(19) United States
(12) Patent Application Publication
(10) Pub. No.: US 2025/0164740 A1
(43) Pub. Date: May 22, 2025

(54) LANDSCAPE DISPLAY AND ORIENTATION ARRANGEMENT FOR VIRTUAL REALITY HEADSETS

(71) Applicant: Meta Platforms Technologies, LLC, Menlo Park, CA (US)

(72) Inventor: Li Zhuang, Bellevue, WA (US)

(21) Appl. No.: 18/954,083

(22) Filed: Nov. 20, 2024

Related U.S. Application Data
(60) Provisional application No. 63/601,495, filed on Nov. 21, 2023.

(51) Int. Cl. G02B 7/12; G09G 3/00

(52) U.S. Cl. CPC G02B 7/12; G09G 3/001; G09G 2340/0478

(57) ABSTRACT

Systems, methods, or devices relate to a head mounted display providing a landscape panel layout. In examples, the landscape panel layout includes at least one optical display having a source driver positioned opposite a nasal region, and at least one chamfer cut along a side of the optical display non-adjacent to the source driver. The at least one chamfer cut generates an increased interpupillary distance (IPD) with a second optical display.

### CROSS-REFERENCE TO RELATED APPLICATIONS

This application claims benefit under 35 U.S.C. § 119 (e) of Provisional U.S. Patent Application No. 63/601,495 filed on Nov. 21, 2023, the contents of which are incorporated herein by reference in its entirety.

### TECHNOLOGICAL FIELD

Examples of the present disclosure may relate generally to methods, apparatuses and computer program products for providing landscape display and orientation arrangement for headsets (e.g., virtual reality headsets).

### BACKGROUND

Interpupillary distance (IPD) is the distance between the centers of a person's pupils. In virtual reality (VR), accurate IPD settings may help align the lenses with the user's eyes. Incorrect IPD may cause visual discomfort, eye strain, or blurred images.

### BRIEF SUMMARY

Virtual reality (VR) products may have two portrait display orientations, each tilted inwards towards an upper, central point in a viewer's direction with a panel corner chamfer cut to help achieve a minimum Interpupillary Distance (IPD) requirement(s) on a nasal side. In order to have higher resolution displays like 3K, 4K, or higher resolution display, a larger size display such as a liquid crystal display (LCD) or an organic light-emitting diode (OLED) display (e.g., other than a micro-OLED display) may be considered. However, the IPD distance may be sharply reduced and colliding between left and right displays may not be able to be avoided with conventional portrait display orientation, particularly on a display driver integrated circuit (DDIC) side with a very limited chamfer cut. Conventional VR products (e.g., headsets) may have a portrait display orientation that has a limitation for IPD adjustment especially when a larger size display with high resolution is introduced.

The examples of the present disclosure provide systems, methods, devices, or computer program products for landscape displays which may be on a head-mounted device. Various examples may include a landscape panel layout having an optical display, wherein the optical display includes a source driver positioned opposite a nasal region. Examples may further include at least one chamfer cut along a side of the optical display non-adjacent to the source driver, to generate an interpupillary distance (IPD) with a second optical display.

In additional examples, a landscape panel layout may swap the source driver position with a gate driver position. The swapped positions may have a 90-degree rotational difference and maintain an existing active area (AA) as the current portrait AA in size and aspect ratio (e.g., keep a longer longitude on a vertical direction). The panel side with a significantly larger chamfer cut, e.g., on a non-DDIC side may be brought into the nasal side to gain more distance between two panels for IPD distance margin to fit future larger size displays.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the present disclosure; however, the disclosed subject matter is not limited to the specific methods, compositions, and devices disclosed. In addition, the drawings are not necessarily drawn to scale. In the drawings:

FIG. 1 illustrates an example interface, in accordance with various aspects discussed herein.

FIG. 2 illustrates an example landscape panel display with driver placement, in accordance with various aspects discussed herein.

FIG. 3 illustrates a back side of an example landscape panel display, in accordance with various aspects discussed herein.

FIG. 4 illustrates a flowchart for producing advertisements via an interface, in accordance with various aspects discussed herein.

FIG. 5 illustrates a block diagram of an example device in accordance with various aspects discussed herein.

FIG. 6 illustrates a block diagram of an example computing system in accordance with various aspects discussed herein.

FIG. 7 illustrates another artificial reality system comprising a headset, in accordance with an example of the present disclosure.

FIG. 8 illustrates a computing system in accordance with various aspects discussed herein.

The figures depict various examples for purposes of illustration only. One skilled in the art will readily recognize from the following discussion that alternative examples of the structures and methods illustrated herein may be employed without departing from the principles described herein.

### DETAILED DESCRIPTION

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed subject matter.

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

References in this description to “an example”, “one example”, or the like, may mean that the particular feature, function, or characteristic being described is included in at least one example of the present invention. Occurrences of such phrases in this specification do not necessarily all refer to the same example, nor are they necessarily mutually exclusive.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

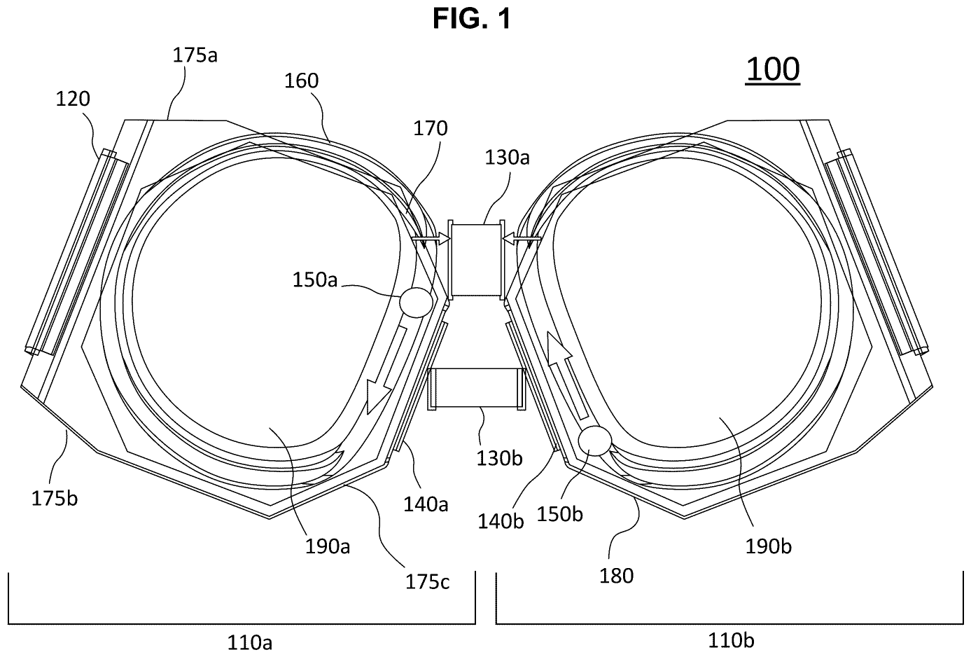

FIG. 1 illustrates an example landscape panel display 100 in accordance with aspects discussed herein. The landscape panel display 100 may include a first optical display 110a and a second optical display 110b on which images may be rendered. The landscape panel display 100, including the first optical display 110a and the second optical display 110b may be part of a head-mounted display, such as a VR headset.

An optical display, e.g., first optical display 110a and/or second optical display 110b, may include the components shown within the respective optical display boxes of FIG. 1. An optical display, e.g., first optical display 110a, may include a source driver, e.g., source driver 120, positioned opposite a nasal region, e.g., nasal region 130a, 130b. Although separate blocks 130a and 130b are illustrated within the nasal region for ease of reference, it should be appreciated that the nasal region includes the entirety of the space between optical displays 110a and 110b. Accordingly, in head-mounted displays and other related applications, a spacing between the first optical display 110a and second optical display 110b may create space for the wearer's nose and enable a closer distance between a lens (e.g., lens 160) of the optical display and the wearer's eyes.

A source driver 120 may be positioned opposite the nasal region, for example, on a side of the optical display that is non-adjacent to the nasal region. The source driver 120 may be usable to supply any necessary voltage to a source, such as pixel electrodes. In an active-matrix display, for example, the source driver 120 may provide analog or digital signals corresponding to image data. The source driver 120 may work in conjunction with a gate driver, which may select the rows or columns of pixels to be activated.

The gate driver may be applied to manage switching of transistors, such as metal-oxide-semiconductor field-effect transistors (MOSFETs) or insulated-gate bipolar transistors (IGBTs), in electronics or switching applications. The gate driver may supply required voltage to the gate of a transistor to turn it on or off. In various examples, gate drivers may assist with activating or deactivating the rows or columns in a matrix of pixels.

A display driver integrated circuit (DDIC) 140a, 140b may be provided opposite to the source driver 120, for example, along a side adjacent to the nasal regions 130a, 130b, and/or on a back side of the optical display. The DDIC may, on its respective optical display, initiate a scan originating at a point, e.g., point 150a or 150b along a direction, as indicated by the respective arrows. The scan may follow a linear path until the end of the first row defined by the DDIC, then begin the scan on the next row. The scan may be a bottoms-up or top-down scanning method, according to desired display preferences. In examples, the DDIC includes a gate driver and a display driver.

In examples, the DDIC may include the source driver and the gate driver, as it is the integrated circuit responsible for controlling the pixels in display panels. The DDIC may manage how images are displayed on screens, and drive the rows (e.g., through the gate driver function) and the columns (e.g., through the source driver function) of a matrix-based display.

A chamfer 170may be cut along a side of the optical display to increase an interpupillary distance between the optical displays (e.g., optical displays 110a, 110b) an enable positioning of a larger lens 160 and active area (AA) (e.g., regions 190a, 190b) on which images may be rendered. The chamfer cut 170 may be a 45-degree angled cut. In some examples, the AA (e.g., regions 190a, 190b) comprises an aspect ratio, such as a 4:3 aspect ratio, multiple thereof, or the like. In various examples, different chamfer cut angles may be used, which may be more or less than 45-degrees.

In some examples, additional chamfer cuts may be provided around the optical display, such as cuts 175a, 175b, and 175c, based on design considerations. In some examples, the additional cuts enable a symmetric shape to the optical display and to help maximize the AA region on the landscape panel layout. The additional chamfer cuts may, but need not, be equivalent angles and lengths. In an example, based on the chamfer cuts (e.g., angled truncations), first optical display 110a and the second optical display 110b may be hexagonal, octagonal, or another shape. As shown, with one or more chamfer cuts may contribute to the overall hexagonal profile.

For example, two additional, chamfer cut corners (see e.g., cut 175c, cut 180) on landscape panel display 100 may be placed on the nasal side between a left eye module (e.g., first optical display 110a) or a right eye module (e.g., second optical display 110b) to provide larger distance between the potential colliding points in an instance in which a user of the headset (e.g., the VR headset) makes an IPD adjustment. In some head set examples, the left and right eye modules may be adjustable for comfort, IPD preferences, or nasal region preferences or requirements.

The upper chamfer cut 170 and bottom chamfer cuts 175c, 180 may be engineered with distinct geometric specifications to serve different functional requirements. In an example, the upper chamfer cut 170 may be implemented at about a 45-degree angle relative to the vertical edge, extending inward 8.5 mm to facilitate the maximum lens diameter of 50 mm while maintaining the target active area. In contrast, the bottom chamfer cuts 175c and 180 may be crafted at about a 30-degree angle relative to the horizontal edge, with a cut depth of 5.2 mm. This shallower angle and shorter cut depth may be optimized to provide 3.8 mm of clearance during maximum IPD adjustment (73 mm) while preventing mechanical interference between the left and right optical modules. The asymmetric chamfer configuration may enable a total IPD adjustment range of 17 mm (from 56 mm to 73 mm) while maintaining optical alignment. During IPD adjustments, in the example, the bottom chamfer geometry may ensure a minimum clearance of about 2 mm between display modules at all adjustment points, preventing potential contact damage while preserving the active display area. This design may allow for mechanical adjustment without compromising the optical performance or structural integrity of the display assembly.

In some examples of the present disclosure, a landscape display, e.g., landscape panel display 100, may be provided with a 90-degree rotation in a headset (e.g., VR headset), compared to traditional portrait eye module displays. The source driver (e.g., source driver 120) may be provided on the left or right side of an output region of the landscape panel layout. An output region may be an electrical output region, such as a region where the source driver, DDIC, or other related hardware, such as a gate driver, and/or a display driver may be positioned. In examples, DDIC may be on the left side (e.g., DDIC 140a) or right side (e.g., DDIC 140b) of the panel in the new arrangement in the headset (e.g., the VR headset). As seen in FIG. 1, the DDIC is positioned on a right side of optical display 110a, while the DDIC is positioned on a left side of the second optical display 110b.

The active area (AA) specifications may be optimized for the landscape orientation while maintaining compatibility with existing VR optical systems. The AA dimensions may be preserved during the 90-degree rotation from portrait to landscape orientation, maintaining a 4:3 aspect ratio with an effective display area o. This configuration supports resolutions that include 4K (3840×2160 pixels) while accommodating the geometric constraints imposed by the chamfer cuts.

The AA's position relative to the source driver and DDIC may optimize signal timing and minimize display latency. The landscape orientation may enable a horizontal scan pattern that reduces the total scan time compared to traditional portrait configurations. This optimization may allow for refresh rates of 90 Hz or higher while maintaining signal integrity across the entire active area.

Integration with the IPD adjustment mechanisms may be achieved through precise positioning of the AA relative to the optical center of the lens. The AA placement may enable full utilization of the available IPD range (56-73 mm) while minimizing optical distortion. At minimum IPD (56 mm), the AAs of adjacent displays maintain a minimum separation that prevents signal interference while maximizing image quality. The chamfer cuts may be positioned to avoid encroachment on the AA, ensuring that the viewable display area remains uncompromised across all IPD settings.

To maintain optimal display performance, the source driver may generate timing signals that account for the rotated AA orientation. The gate driver lines may be arranged perpendicular to the source lines, with the intersection points defining the active pixels within the AA. This arrangement may ensure uniform brightness and color reproduction across the entire display surface.

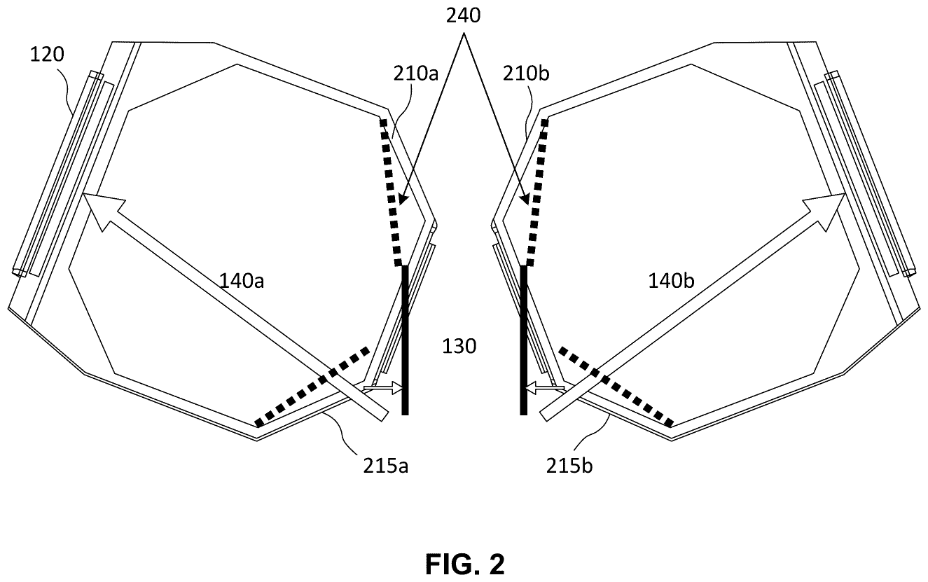

FIG. 2 illustrates a landscape panel layout having optical displays wherein the source driver 120 and the DDIC (e.g., DDIC 140a) are positioned along a same side of the display and therefore create a landscape panel with an even greater IPD spacing 240 without reduction of the active area. The positioning of the source driver 120 and DDIC 140a along a same side, e.g., opposite a nasal region 130, may enable a deeper chamfer cut on a side adjacent to the nasal region 130. Upper chamfer cuts 210a and 210b may be cut at a first angle relative to an adjacent side, and lower chamfer cuts 215a and 215b may be cut at a second angle relative to an adjacent side. The upper chamfer cuts 210a and 210b may bet cut at a shallower angle than the lower chamfer cuts 215a and 215b. In some examples, the upper chamfer cuts 210a and 210b and lower chamfer cuts 215a and 215b are cut at similar angles relative to their respective, adjacent sides. The upper chamfer cuts 210a and 210b may be implemented at about a 35-degree angle relative to the vertical edge, while the lower chamfer cuts 215a and 215b employ about a steeper 60-degree angle. This asymmetric configuration may serve multiple purposes. In a first example, the shallower 35-degree upper cuts may maximize the IPD spacing while preserving sufficient material for structural integrity where the display interfaces with the headset frame. In a second example, the steeper 60-degree lower cuts may create additional clearance for the DDIC and source driver positioning along the same side (140a), enabling optimal signal routing while maintaining necessary interpupillary distance 240. This angular difference may result in about a 25-degree differential that may enable an increased IPD range compared to the configuration shown in FIG. 1, while accommodating the consolidated driver placement along a single edge. As disclosed herein, these measurements are exemplary and may be adjusted for other implementations. For example, the angles may be +/−10 degrees.

FIGS. 1 and 2 contrast from traditional portrait-based optical displays, with optical components, such as the source driver and DDIC 140a to be positioned along a side adjacent to the nasal region, such as a top side or a bottom side, However, such portrait-based optical displays and orientations may prevent similar chamfer cuts and limits orientation of the optical displays and lenses within the head-mounted device.

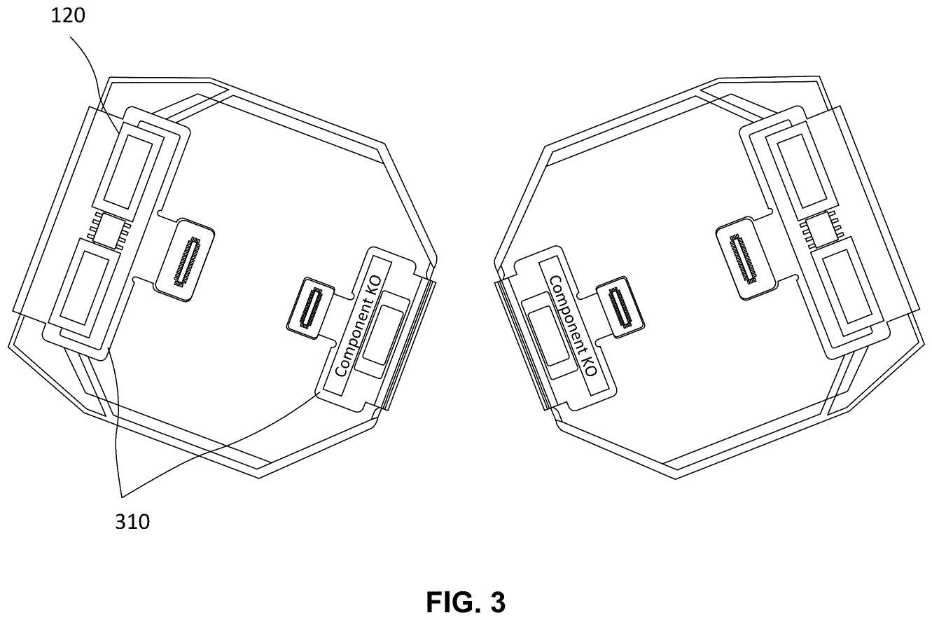

FIG. 3 illustrates a back side 300 of the landscape panel layout illustrated in FIGS. 1 and 2. The back side illustrates the source driver 120 and a flexible printed circuit (FPC) 310 provided opposite the nasal region. In examples, the FPC 310 may connect the optical display with a display driver and other electrical and optical components.

FPCs 310 may be preferred for use in applications, such a head-mounted displays, due to their flexibility, connectivity potential, space efficiency, or durability. The flexibility nature of FPCs 310 may allow them to be twisted or shaped to fit into compact or irregularly shaped spaces, such as head-mounted displays, thin or curved environments, or optical devices. FPCs 310 may link various electrical components such as various drivers, light sources, or control circuits. FPCs 310 may be efficient, lightweight, and durable, which may contribute to consistency and longevity for applications in which the FPC 310 is used.

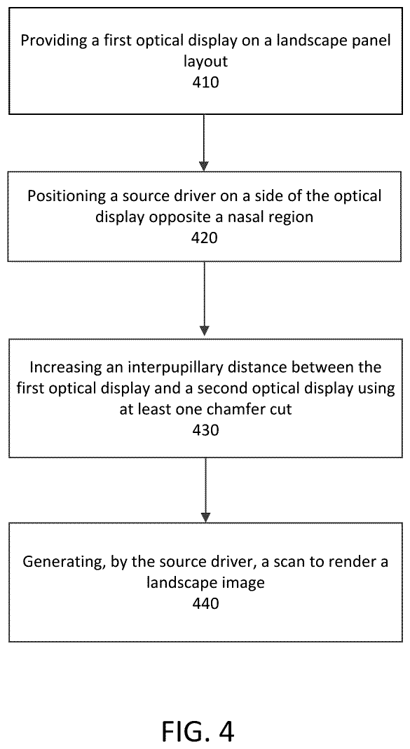

FIG. 4 illustrates a flow chart for rendering a landscape image on a landscape panel layout. At block 410, aspects may provide a first optical display on a landscape panel layout. In examples, the landscape panel layout may include an optical display, wherein the optical display includes a source driver positioned opposite a nasal region. The landscape panel layout may further include a flexible printed circuit (FPC) provided opposite the nasal region connecting the optical display with a display driver associated with the landscape panel layout. The FPC may be provided on a back side of the optical display.

The landscape panel layout may further include a second optical display symmetrically positioned on an opposite side of the nasal region. The layout may further include a display driver integrated circuit (DDIC) (e.g., DDIC 140a), which may include a gate driver, and a display driver. The DDIC is positioned in a back side of the optical display.

At block 420, aspects may position a source driver on a side of the optical display opposite a nasal region. In examples, the optical display further includes a gate driver, and wherein the source driver is rotationally positioned at least 90 degrees relative to the gate driver. The source driver may be positioned on a left side or a right side of a panel output location. The source driver may generate an active area (AA) (e.g., regions 190a, 190b) approximately equivalent to a portrait AA in size and aspect ratio, which may be 4:3.

At block 430, aspects may increase an interpupillary distance between the first optical display and a second optical display using at least one chamfer cut. The at least one chamfer cut may be provided along a side of the optical display non-adjacent to the source driver, to increase an interpupillary distance (IPD) with a second optical display. The chamfer cut may be angled to increase a distance between two optical regions and create an IPD margin to fit at least one lens. The IPD may be 56-73 mm.

At block 440, aspects may generate, by the source driver, a scan to render a landscape image. In examples, at least one of the source driver and the DDIC, which may include the source driver, may render a landscape image by generating a scan initiating from a side of the optical display adjacent to the nasal region. The scan may have a refresh rate of at least 60 Hz, such as 60 Hz, 120 Hz, or greater.

The disclosed subject matter may provide for advancements in head-mounted display ergonomics, which may improve interpupillary adjustability while maintaining display performance. For example, the landscape orientation, combined with strategic component placement and chamfer geometry may enable accommodation of larger high-resolution displays without the spatial constraints inherent in traditional portrait configurations. For example, the display arrangement may incorporate a chamfer system including: a primary chamfer cut 170 along a side non-adjacent to the source driver with an approximate minimum 45-degree angle, supplementary chamfer cuts 175a, 175b for geometric optimization, and enhanced nasal region chamfer cuts 175c, 180 specifically engineered to facilitate interpupillary distance (IPD) adjustment. A precision-positioned lens 160 may be positioned over each optical display. The comprehensive chamfer configuration may enable increased spacing between optical regions to accommodate IPD ranging from 56-73 mm while maintaining display performance. The source drivers may be rotationally offset approximately 90 degrees relative to gate drivers, which may enable efficient signal routing while preserving display area. Each optical display may incorporate a source driver 120 positioned opposite the nasal region. Display driver integrated circuits (DDICs) 140a, 140b may be positioned adjacent to the nasal region and initiate scanning from points 150a, 150b respectively.

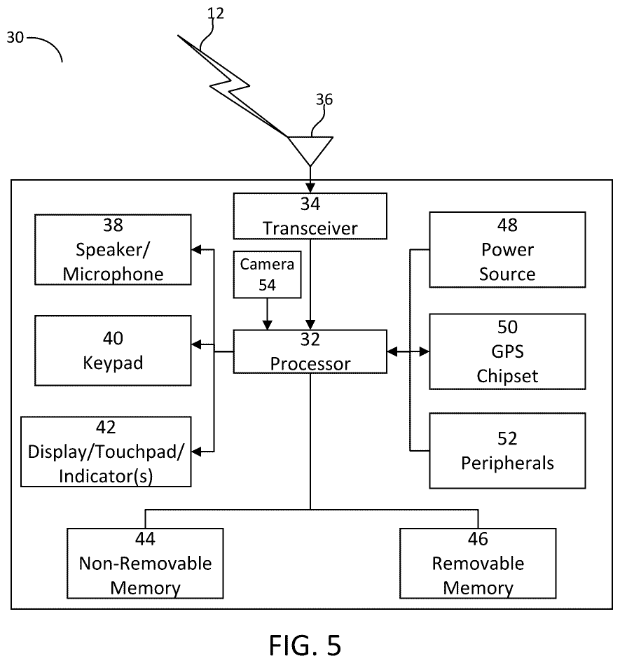

FIG. 5 illustrates a block diagram of an example hardware/software architecture of a UE 30. As shown in FIG. 5, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 may be a smart camera configured to sense images appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCad), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

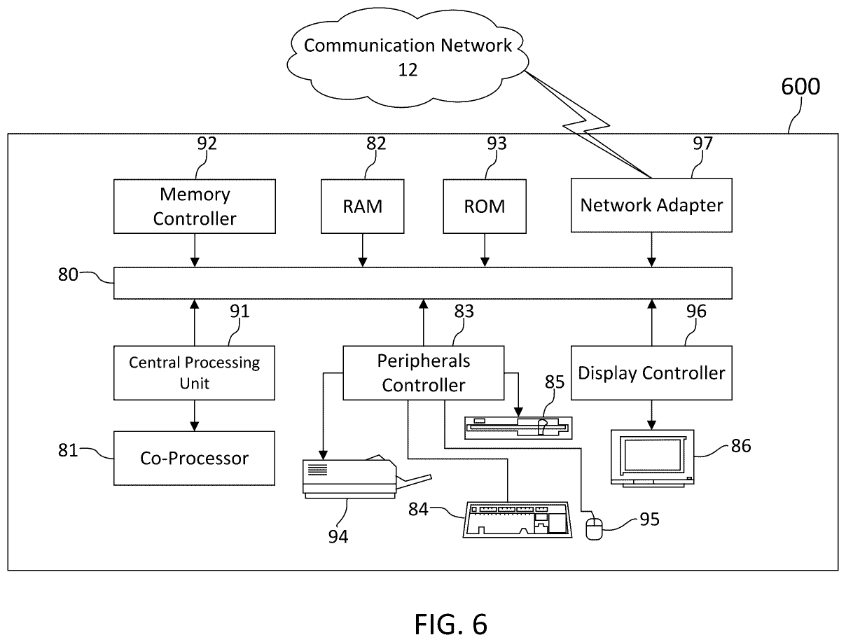

FIG. 6 is a block diagram of a computing system 600 which may also be used to implement components of the system or be part of the UE 30. The computing system 600 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 600 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 600 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that may not easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 600 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 600. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 600 may contain communication circuitry, such as for example a network adaptor 97, that may be used to connect computing system 600 to an external communications network, such as network 12 of FIG. 5, to enable the computing system 600 to communicate with other nodes (e.g., UE 30) of the network.

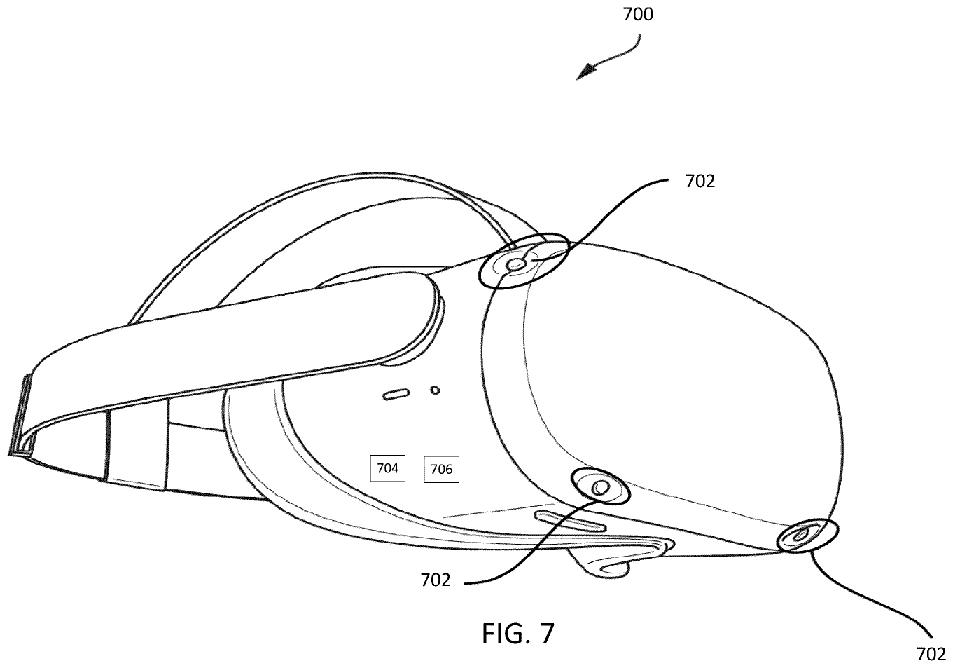

FIG. 7 illustrates another example of an artificial reality system including a head-mounted display (HMD) 700, image sensors 702 mounted to (e.g., extending from) HMD 700, according to at least one example aspect of the present disclosure. In some example aspects, image sensors 702 may be mounted on and protruding from a surface (e.g., a front surface, a corner surface, etc.) of HMD 700. In some exemplary aspects, HMD 700 may include an artificial reality system/virtual reality system. In an exemplary aspect, image sensors 702 may include, but are not limited to, one or more sensors (e.g., cameras 54, peripherals 52, etc.), a memory 706 (e.g., RAM, ROM) and a processor 704 (e.g., a controller (e.g., controller 704)). In exemplary embodiments, a compressible shock absorbing device may be mounted on image sensors 702. The shock absorbing device may be configured to substantially maintain the structural integrity of image sensors 702 in case an impact force is imparted on image sensors 702. In some exemplary embodiments, image sensors 702 may protrude from a surface (e.g., the front surface) of HMD 700 so as to increase a field of view of image sensors 702. In some examples, image sensors 702 may be pivotally and/or translationally mounted to HMD 700 to pivot image sensors 702 at a range of angles and/or to allow for translation in multiple directions, in response to an impact. For example, image sensors 702 may protrude from the front surface of HMD 700 so as to give image sensors 702 at least a 180 degree field of view of objects (e.g., a hand, a user, a surrounding real-world environment, etc.).

Some example aspects of the present disclosure may provide systems and methods for generating adaptive content for a user(s) associated with a head-mounted display (e.g., HMD 410, HMD 700). In this regard, some example aspects of the present disclosure may provide adaptive content which may significantly enhance a user(s) experience by promoting personalization, interactivity, and endless possibilities. By providing virtual environments that incorporate dynamic content driven by user input and/or preferences, the exemplary aspects may facilitate a wide range of interests and needs of users, offering tailored experiences that resonate with each user. Furthermore, user-generated content (e.g., adaptive content) provided by the exemplary aspects may empower users to express their creativity and influence the virtual environment, fostering a sense of ownership and investment in a platform (e.g., a network (e.g., a social media network)). This increased immersion and engagement by users may lead to a richer, more fulfilling experience, driving user retention and promoting the growth and longevity of virtual environments.

Some example aspects of the present disclosure may utilize the inputs from various sensors of a device (e.g., an AR device) that captures the states of a user to utilize this captured information to drive/provide generative AI assistance and/or generative AI content creation mechanisms.

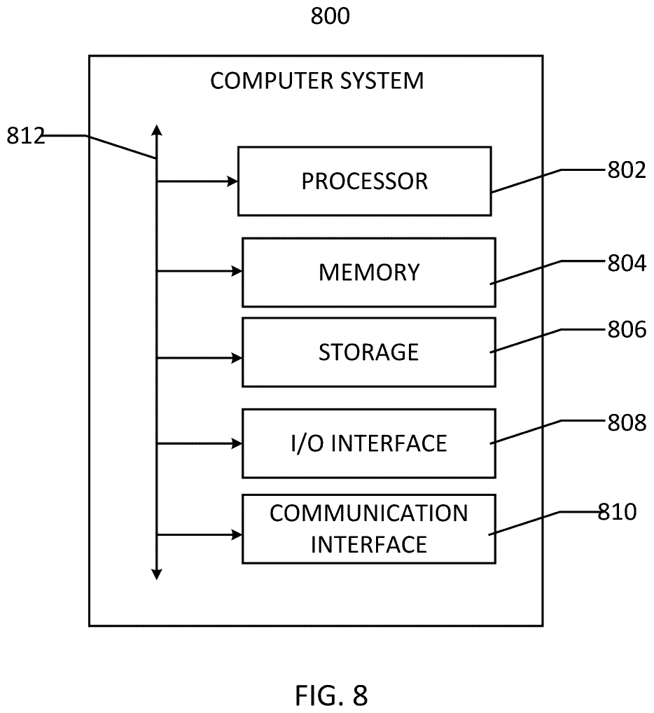

FIG. 8 illustrates an example computer system 800. In examples, one or more computer systems 800 perform one or more steps of one or more methods described or illustrated herein. In particular embodiments, one or more computer systems 800 provide functionality described or illustrated herein. In examples, software running on one or more computer systems 800 performs one or more steps of one or more methods described or illustrated herein or provides functionality described or illustrated herein. Examples include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example, and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In examples, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In examples, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example, and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In examples, memory 804 includes main memory for storing instructions for processor 802 to execute or data for processor 802 to operate on. As an example, and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In examples, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In examples, storage 806 includes mass storage for data or instructions. As an example, and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In examples, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In examples, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In examples, communication interface 810 includes hardware, software, or both providing one or more interfaces for communication (such as, for example, packet-based communication) between computer system 800 and one or more other computer systems 800 or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example, and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Methods, systems, or apparatus with regard to panel layouts are disclosed herein. A head mounted display or other device may include a landscape panel layout including an optical display with a source driver positioned opposite a nasal region, and at least one chamfer cut along a side of the optical display non-adjacent to the source driver to generate an increased interpupillary distance (IPD) with a second optical display. A flexible printed circuit (FPC) may be provided opposite the nasal region on a back side of the optical display, connecting the optical display with a display driver associated with the landscape panel layout. The landscape panel layout may further include a second optical display symmetrically positioned on an opposite side of the nasal region. The optical display may include a gate driver, wherein the source driver is rotationally positioned at least 90 degrees relative to the gate driver and generates an active area (AA) equivalent to a portrait AA in size and aspect ratio, such as a 4:3 aspect ratio. A display driver integrated circuit (DDIC) including a gate driver and display driver may be positioned on a back side of the optical display, wherein the DDIC renders a landscape image by generating a scan initiating from a side of the optical display adjacent to the nasal region with a refresh rate of at least 60 Hz. The chamfer cut may be angled at least 45 degrees to increase a distance between two optical regions and create an IPD margin of 56-73 mm to fit at least one lens. The source driver may be positioned on either a left side or right side of an output region of the landscape panel layout. All combinations (including the removal or addition of steps) in this paragraph and the above paragraphs are contemplated in a manner that is consistent with the other portions of the detailed description.

A method may include providing a first optical display on a landscape panel layout; positioning a source driver on a side of the optical display opposite a nasal region; increasing an interpupillary distance (IPD) between the first optical display and a second optical display using at least one chamfer cut along a first side of the first optical display non-adjacent to the source driver; and generating, by the source driver, a scan to render a landscape image, wherein the scan is initiated from a side of the optical display adjacent to the nasal region. The scan may have a refresh rate of at least 60 Hz, 120 Hz, or greater. The chamfer cut may be at least a 45-degree angle cut and the IPD may be at least 56 mm. The method may further include connecting the optical display with a display driver using a flexible printed circuit (FPC) provided opposite the nasal region on a back side of the optical display, and generating, by the source driver, an active area (AA) equivalent to a portrait AA in size and aspect ratio, such as 4:3. All combinations (including the removal or addition of steps) in this paragraph and the above paragraphs are contemplated in a manner that is consistent with the other portions of the detailed description.

A head mounted display may include an optical display, wherein the optical display comprises a source driver, wherein the source driver is positioned opposite a nasal region, and a gate driver. The optical display may comprise at least one chamfer cut along a side of the optical display non-adjacent to the source driver, wherein the source driver is rotationally positioned at least 90 degrees relative to the gate driver. In various examples, the head mounted display may further comprise a flexible printed circuit (FPC) provided on a backside of the optical display. The FPC may connect the optical display with a display driver.

What is claimed:

1. An apparatus comprising:
an optical display,
wherein the optical display comprises a source driver positioned opposite a nasal region; and
wherein the optical display comprises at least one chamfer cut along a side of the optical display non-adjacent to the source driver.

2. The apparatus of claim 1, further comprising a flexible printed circuit (FPC) provided opposite the nasal region connecting the optical display with a display driver associated with a landscape panel layout.

3. The apparatus of claim 2, wherein the FPC is provided on a back side of the optical display.

4. The apparatus of claim 2, wherein the landscape panel layout further comprises a second optical display symmetrically positioned on an opposite side of the nasal region.

5. The apparatus of claim 1, wherein the optical display further comprises a gate driver, and wherein the source driver is rotationally positioned at least 90 degrees relative to the gate driver.

6. The apparatus of claim 1, wherein the source driver generates an active area (AA) equivalent to a portrait AA in size and aspect ratio.

7. The apparatus of claim 6, wherein the AA comprises an aspect ratio of 4:3.

8. The apparatus of claim 1, further comprising a display driver integrated circuit (DDIC) comprising a gate driver, and a display driver, wherein the DDIC is positioned on a back side of the optical display.

9. The apparatus of claim 8, wherein the DDIC renders a landscape image by generating a scan initiating from a side of the optical display adjacent to the nasal region, wherein the scan has a refresh rate of at least 60 Hz.

10. The apparatus of claim 1, wherein the chamfer cut is angled to increase a distance between two optical regions and create an interpupillary distance (IPD) margin to fit at least one lens.

11. The apparatus of claim 10, wherein the IPD is 56-73 mm.

12. The apparatus of claim 1, wherein the source driver is positioned on a left side or a right side of an output region of a landscape panel layout.

13. The apparatus of claim 1, wherein the chamfer cut is at least a 45-degree angle cut.

14. A method for rendering images on a head-mounted display, comprising:
providing a first optical display on a landscape panel layout;
positioning a source driver on a side of the optical display opposite a nasal region; and
increasing an interpupillary distance (IPD) between the first optical display and a second optical display, based on using at least one chamfer cut along a first side of the first optical display, wherein the first side is non-adjacent to the source driver.

15. The method of claim 14, further comprising generating, by the source driver, a scan to render a landscape image, wherein the scan is initiated from a side of the optical display adjacent to the nasal region.

16. The method of claim 14, wherein the chamfer cut is at least a 45-degree angle cut and the IPD is at least 56 mm.

17. The method of claim 14, further comprising connecting the optical display with a display driver using a flexible printed circuit (FPC), wherein the FPC is provided opposite the nasal region, on a back side of the optical display.

18. The method of claim 14, further comprising generating, by the source driver, an active area (AA) equivalent to a portrait AA in size and aspect ratio.

19. A head mounted display comprising:
an optical display,
wherein the optical display comprises:
a source driver, wherein the source driver is positioned opposite a nasal region; and
a gate driver; and
wherein the optical display comprises at least one chamfer cut along a side of the optical display non-adjacent to the source driver, wherein the source driver is rotationally positioned at least 90 degrees relative to the gate driver.

20. The head mounted display of claim 19, further comprising a flexible printed circuit (FPC) provided on a backside of the optical display, wherein the FPC connects the optical display with a display driver.
